(19) United States
(12) Patent Application Publication
(10) Pub. No.: US 2018/0184260 A1
(43) Pub. Date: Jun. 28, 2018

(54) Message Sending and Receiving Methods and Apparatuses

(71) Applicant: Alibaba Group Holding Limited, Grand Cayman (KY)

(72) Inventor: Liang LI, Hangzhou (CN)

(21) Appl. No.: 15/893,483

(22) Filed: Feb. 9, 2018

Related U.S. Application Data
(63) Continuation of application No. PCT/CN2016/093187, filed on Aug. 4, 2016.

(30) Foreign Application Priority Data
Aug. 13, 2015 (CN) 201510498533.1

(51) Int. Cl. H04W 4/14

(52) U.S. Cl. CPC H04W 4/14

(57) ABSTRACT

A method and an apparatus for sending and receiving a message are disclosed. The method includes converting information content of a message to be sent into byte data; searching for characters corresponding to the byte data from a pre-stored character set to obtain character data, wherein the character set includes predetermined byte data, predetermined characters, and mapping relationships between the predetermined byte data and the predetermined characters, and the predetermined characters are characters that are supported by messages; and sending the character data through messaging. The present disclosure solves the technical problems of limited areas of uses of a message due to a length limitation for content in the message.

### CROSS REFERENCE TO RELATED PATENT APPLICATIONS

This application claims priority to and is a continuation of PCT Patent Application No. PCT/CN2016/093187 filed on 4 Aug. 2016, and is related to and claims priority to Chinese Patent Application No. 201510498533.1, filed on 13 Aug. 2015, entitled “Message Sending and Receiving Methods and Apparatuses,” which are hereby incorporated by reference in their entirety.

### TECHNICAL FIELD

The present disclosure relates to the technological field of the Internet, and particularly to message sending and receiving methods and apparatuses.

### BACKGROUND

A method of communications between a server and a client is to establish a network connection. However, a network connection may not exist in some environments. Under these circumstances, data communications between a client and a server can be conducted via messages. Moreover, messages are also used for communications with mobile numbers. In general, messages can only support transmission of Unicode textual content, with a length of 70. Since messages have a length limitation and content thereof is publicly readable, the messages, which act as content that can be sent in complex communications, are suffered a great deal of limitations.

A solution of anti-theft of mobile phones provided by a related technology is to send a command to a target mobile phone through a mobile phone of a friend or relative. However, due to a number of limitations for messages, an existing implementation is to send a predefined command code only, without the capability of including more detailed parameters, thus having very limited security and areas of use.

Currently, no effective solution has been proposed for the above problems.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

Embodiments of the present disclosure provide message sending and receiving methods and apparatuses, to solve the technical problems of limited areas of uses of a message due to a length limitation for content in the message.

In implementations, a message sending method is provided, which includes converting information content of a message to be sent into byte data; searching for characters corresponding to the byte data from a pre-stored character set to obtain character data, wherein the character set includes predetermined byte data, predetermined characters, and mapping relationships between the predetermined byte data and the predetermined characters, and the predetermined characters are characters that are supported by messages; and sending the character data by means of messaging.

In implementations, a message receiving method is provided, which includes receiving a message from a sending party; finding character data corresponding to information content of the message from a pre-stored character set, the character set includes predetermined byte data, predetermined characters, and mapping relationships between the predetermined byte data and the predetermined characters; and restoring the found character data to original information content of the message.

In implementations, a message sending apparatus is provided, which includes a conversion module used for converting information content of a message to be sent into byte data; a searching module used for searching for characters corresponding to the byte data from a pre-stored character set to obtain character data, wherein the character set includes predetermined byte data, predetermined characters, and mapping relationships between the predetermined byte data and the predetermined characters, and the predetermined characters are characters that are supported by messages; and a sending module used for sending the character data by means of messaging.

In implementations, a message receiving apparatus is provided, which includes a receiving module used for receiving a message from a sending party; a searching module used for finding character data corresponding to information content of the message from a pre-stored character set, the character set includes predetermined byte data, predetermined characters, and mapping relationships between the predetermined byte data and the predetermined characters; and a restoration module used for restoring the found character data to original information content of the message.

In implementations, information content of a message to be sent is converted into byte data. Based on mapping relationships between predetermined byte data and predetermined characters in a pre-stored character set, character data corresponding to the byte data, which has been converted from the information content, is found from the pre-stored character set. This character data is then sent out by means of messaging. Therefore, under a condition that data length is not increased, the byte data which has been converted from the information content is converted into a text that is transmissible by a message, thus improving the goal of transmitting information content of complex communications. This thereby solves the technical problems of limited areas of use of messages due to a length limitation for content in the messages, and expands the areas of use of the messages.

### BRIEF DESCRIPTION OF THE DRAWINGS

Accompanying drawings that are described herein are used for providing further understanding of the present disclosure, and form a part of the present disclosure. Illustrative embodiments and a description thereof are used for explaining the present disclosure, and are not construed as an improper limitation of the present disclosure. In the drawings:

FIG. 1 is a hardware structural block diagram of a computing terminal of a message sending method in accordance with an embodiment of the present disclosure.

FIG. 2 is a flowchart of a message sending method in accordance with a first embodiment of the present disclosure.

FIG. 3 is a flowchart of a message receiving method in accordance with a second embodiment of the present disclosure.

FIG. 4 is a structural block diagram of a first message sending apparatus in accordance with an embodiment of the present disclosure.

FIG. 5 is a structural block diagram of a second message sending apparatus in accordance with an embodiment of the present disclosure.

FIG. 6 is a structural block diagram of a third message sending apparatus in accordance with an embodiment of the present disclosure.

FIG. 7 is a structural block diagram of a fourth message sending apparatus in accordance with an embodiment of the present disclosure.

FIG. 8 is a structural block diagram of a first message receiving apparatus in accordance with an embodiment of the present disclosure.

FIG. 9 is a structural block diagram of a second message receiving apparatus in accordance with an embodiment of the present disclosure.

FIG. 10 is a structural block diagram of a computing terminal in accordance with a fifth embodiment of the present disclosure.

FIG. 11 is a structural block diagram of the apparatus as described in FIGS. 4-10 in more detail.

### DETAILED DESCRIPTION

In order to enable one skilled in the art to understand technical solutions of the present disclosure in a better manner, the solutions of the embodiments of the present disclosure are described in a clear and comprehensive manner in conjunction with the accompanying drawings of the embodiments of the present disclosure. Apparently, the described embodiments merely represent some and not all of the embodiments of the present disclosure. Based on the embodiments in the present disclosure, all other embodiments that are obtained by one of ordinary skill in the art without making any creative effort will all fall within the scope of protection of the present disclosure.

It should be noted that terms such as “first”, “second” in the specification, claims and drawings of the present disclosure are used for distinguishing similar objects, and are not intended to describe a particular order or ordering. It can be understand that this used data can be exchanged under a suitable situation, such that the embodiments of the present disclosure described herein can be implemented in an order other than the ones shown or described herein. Moreover, terms such as “include”, “have” or other variations thereof are intended to cover non-exclusive inclusion. For example, a process, method, system, product or device including a series of operations or elements not only includes those operations or elements clearly listed, but may also include other operations or elements not explicitly listed, or inherent operations or elements of the process, method, system, product or device.

### First Embodiment

According to the present embodiment of the present disclosure, an exemplary message sending method is also provided. It should be noted that operations shown in a flowchart of an accompanying drawing can be executed in a computing system having computer-executable instructions. Moreover, although a flowchart shows a logical order, operations can be executed in an order different from the one as shown or described herein.

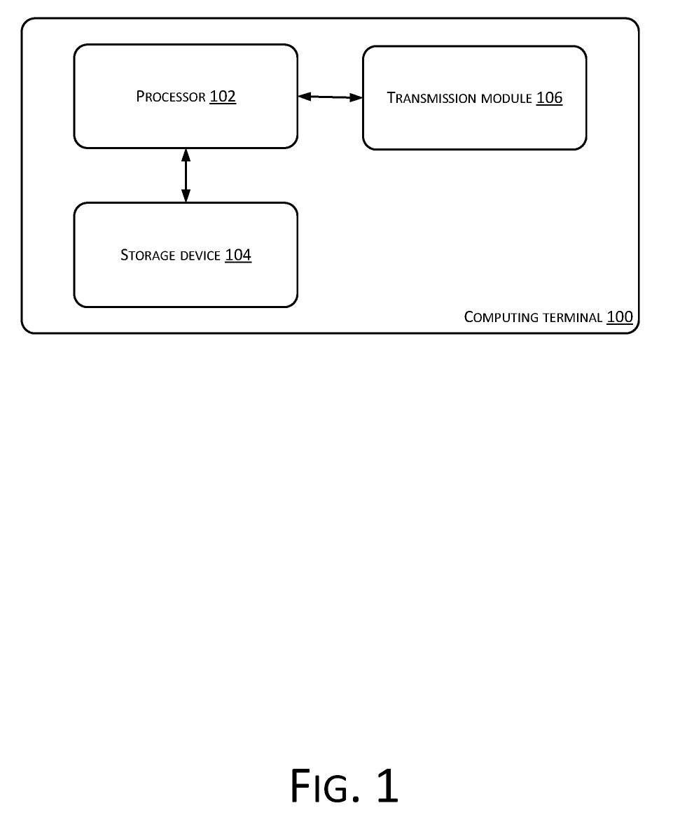

The exemplary method provided by the first embodiment can be executed in a mobile terminal, a computing terminal or a similar computing apparatus. A computing terminal is used as an example. FIG. 1 is a hardware structural block diagram of a computing terminal 100 associated with a message sending method in accordance with an embodiment of the present disclosure. As shown in FIG. 1, a computing terminal 100 may include one or more processors 102, (the processor 102 may include, but is not limited to, a processing apparatus such as a micro-processor (MCU) or a programmable logic device FPGA), a storage device 104 used for storing data, a transmission module 106 used for communication functions. One of ordinary skill in the art can understand that the structure shown in FIG. 1 is merely illustrative, and is not construed as limitations to the above electronic apparatus. For example, the computing terminal 100 may also include more or fewer components as shown in FIG. 1, or have a configuration that is different from the one shown in FIG. 1.

The storage device 104 can be used for storing software programs or modules of software, such as program instructions/modules corresponding to a message sending method of the embodiments of the present disclosure. The processors 102 executes various functional applications and data processing by running software program(s) and module(s) stored in the storage device 104, i.e., implementing the message sending method of the above software program. The storage device 104 may include a high-speed random access memory, and may also include non-volatile memory, such as one or more magnetic storage apparatus, flash storage, or other non-volatile solid state memory. In some embodiments, the storage device 104 may further include remotely configured storage devices corresponding to the processors 102. These remote storage devices may be connected to the computing terminal 10 through a network. Examples of the network include, but are not limited to, the Internet, an intranet, a local area network, a mobile communication network, or a combination thereof.

The transmission module 106 is used for receiving or sending data through a network. An example of the network may include a wireless network provided by a communication provider of the computing terminal 100. In implementations, the transmission module 106 includes a network interface controller (NIC), which can conduct communications with the Internet by connecting with base station(s) and other network devices. In an embodiment, the transmission module 106 may be a radio frequency (RF) module, which is used for conducting communications with the Internet through a wireless method.

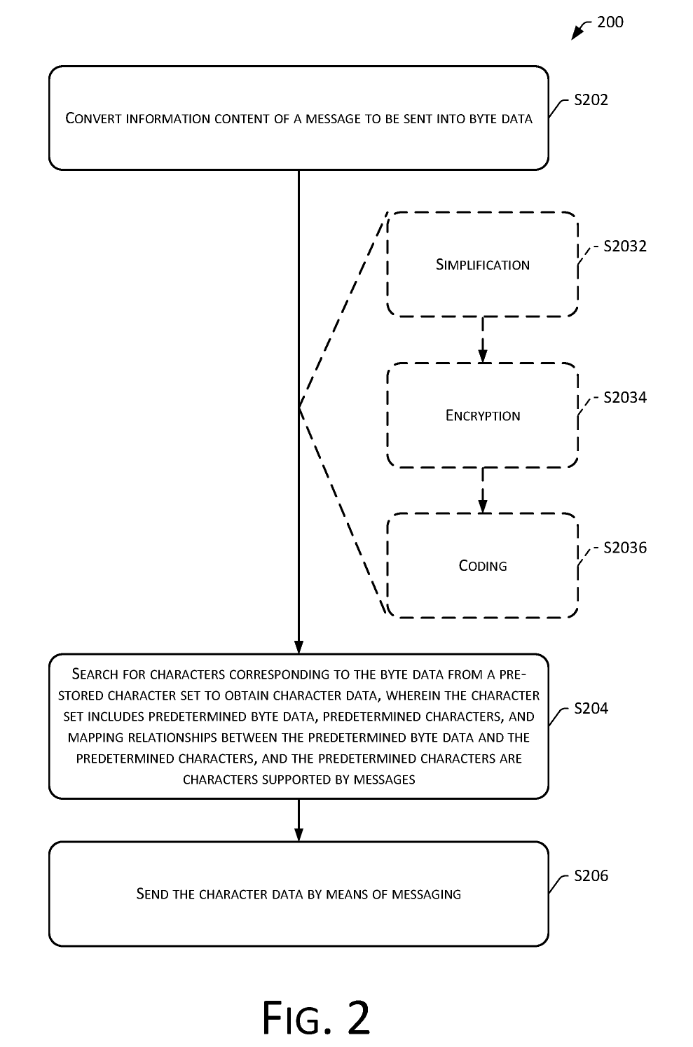

Under the above running environment, the present disclosure provides a message sending method as shown in FIG. 2. FIG. 2 is a flowchart of a message sending method 200 in accordance with the first embodiment of the present disclosure. As shown in FIG. 2, the method 200 includes the following operations.

S202 converts information content of a message to be sent into byte data.

It should be noted that a number of approaches can exist for converting information content of a message to be sent into byte data. In implementations, the following approach may be used for implementation: obtaining a character string corresponding to information content; extracting values of the character string; using the extracted values as array elements to construct a byte array; and using elements of the byte array as byte data. By extracting the values of the character string corresponding to the information content, simplification is performed on the character string to generate a byte array, thus reducing a length of information content that needs to be sent in a certain extent. It should be noted that this type of simplification process may not be executed and information content can directly be converted into character data, if information content of a message to be sent does not exceed a length that can be sent in a single message after performing coding through conventional coding or a pre-stored character set.

In implementations, data models of the elements in the above byte array can be defined adaptively. In implementations, data models of the elements can be adjusted according to respective character lengths of the elements in the byte array. Different data models have different byte lengths. By adaptively defining respective data models in byte data, a number of byte that is needed by a byte array can be reduced.

“[command=5, cmdid=48000000, timestamp=1418269187005, imei=863121027176726, pwd=123456, data1=1418269187005, data2=1418269187005, data3=1418269187005]” is used as an example of a character string corresponding to information content of a message. A length of this character string is 142 characters. In a specific embodiment, for this character string, an array that is obtained by extracting values from the character string is [5, 48000000, 1418269187005, 863121027176726, 123456, 1418269187005, 1418269187005, 1418269187005]. Based on data lengths of elements in this array, respective data models of the elements can be adapted. For example, the first element is 5. As such, only one byte is needed for representation. Therefore, a data model of this first element can be limited as a byte type, without the need of limiting the data model as an int type or a long type. For other elements, a similar approach can be used for adaptively defining data models of these elements. For the above array, respective data models of the elements of the array obtained by adaptively defining the data models are [byte, long, long, long, int, long, long, long] respectively. As can be seen, this array can be represented by 53 bytes only. As can be seen, using the foregoing implementations, data that originally needs 142 characters for representation can be represented by 53 characters only through the above processing method. Furthermore, the above data becomes a byte array of a length of 53.

S204 searches for characters corresponding to the byte data from a pre-stored character set to obtain character data, wherein the character set includes predetermined byte data, predetermined characters, and mapping relationships between the predetermined byte data and the predetermined characters, and the predetermined characters are characters supported by messages.

It should be noted that the pre-stored character set can be determined through the following approach: selecting a predetermined number of characters from a character set that is supported by messages according to predetermined rule(s), the selected characters being not duplicated; and establishing mapping relationships between various pieces of byte data and the predetermined number of the selected characters. The character set that is supported by the messages may be a character set that supports transmission of Unicode. Furthermore, selecting the predetermined number of characters from the character set can be a selection according to certain rule(s), or can be a random selection, provided that the selected characters of the predetermined number are not duplicated. In implementations, the predetermined number may be 256, i.e., a range that can be represented by one byte.

For example, 256 non-duplicate characters are selected from an Unicode character set to obtain a pre-stored character set as [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] . Mapping relationships between respective positions or sequence numbers of characters in the pre-stored character set and the characters can be mapping relationships between various pieces of byte data and the predetermined number of selected characters, which is not limited herein.

S206 sends the character data by means of messaging.

{pwd=12345} is used as an example of data corresponding to information content of a message that is sent and converted into such a byte array, for example, [114, 86, 50, 67, 88, 81, 54, 78, 68, 65, 66, 104, 114, 71, 108, 76, 106, 102, 99, 86, 51, 103, 61, 61]. If content of this byte array is treated as a string for transmission, a length thereof is 80, longer than a message. Using the above example method, if the pre-stored character set is the character set that is predetermined in the above embodiment, by corresponding a value of each byte in the byte array to a character in the pre-stored character set as described above, the byte array is changed into: [symbol] [symbol] [symbol] with a length of 24, after coding. Character data that is obtained is: [symbol] [symbol] [symbol] [symbol] . Therefore, in implementations, a length of content of a message that is sent by messaging is greatly reduced by using a pre-stored character set for coding. The degree of complexity of the information content is thus increased, expanding the usage scope of the message.

For another example, original content of a message to be sent includes “Today, Americans everywhere remember the brave men and women of @NASA who lost their lives in our Nation's eternal quest to expand the boundaries of human potential.” A length of this original content is 165 bytes.

A byte length of an array after encryption is 236, which includes [51, 101, 106, 76, 79, 114, 52, 65, 82, 85, 72, 117, 76, 49, 89, 116, 47, 116, 108, 116, 104, 87, 77, 49, 67, 86, 53, 56, 104, 65, 89, 65, 74, 121, 53, 104, 79, 51, 70, 107, 105, 111, 83, 85, 105, 74, 90, 75, 43, 54, 83, 43, 102, 54, 121, 111, 108, 113, 106, 100, 47, 98, 119, 50, 55, 82, 118, 43, 112, 56, 114, 53, 121, 97, 112, 115, 82, 86, 88, 111, 88, 103, 50, 47, 88, 85, 82, 75, 68, 120, 69, 75, 105, 100, 111, 110, 106, 99, 82, 76, 86, 88, 99, 72, 75, 118, 72, 80, 69, 56, 102, 88, 118, 54, 65, 69, 85, 85, 56, 80, 82, 106, 83, 89, 119, 50, 97, 113, 107, 97, 89, 100, 115, 112, 55, 79, 69, 115, 67, 122, 121, 99, 110, 86, 113, 47, 114, 56, 70, 54, 114, 104, 80, 79, 54, 86, 73, 81, 105, 83, 43, 50, 120, 120, 89, 89, 78, 82, 105, 118, 48, 47, 73, 67, 99, 53, 78, 52, 89, 75, 81, 101, 121, 83, 120, 79, 70, 76, 116, 48, 71, 90, 113, 98, 70, 82, 50, 119, 105, 113, 121, 114, 57, 43, 86, 78, 100, 114, 83, 48, 99, 89, 114, 43, 65, 115, 43, 51, 105, 89, 102, 84, 87, 119, 67, 104, 67, 82, 43, 47, 70, 52, 43, 102, 119, 61].

A dictionary used for conversion of the above array may include “0ÀÁÂÃÄÅÆÇÈÉÊËÌÍÎÏ1ÐÑÒÓÔÕÖ×ØÙÚÛÜÝ [symbol] 2àáâãäåæçèéêëìíîï3ðñòóôõö÷øùúûüý [symbol] ÿ4ĀāĂăA̧a̧\grave{C}\grave{c}ĈĉĊċČčĎd′5Ð [symbol] ĒēĔĕĖ\vec{e}Ȩȩ\check{E}ěĜĝĞğ6Ġġ [symbol] ǵĤĥ [symbol] ℏĨĩĪīĬĭJ̧j̧7\dot{l}lIJijĴĵ [symbol] kĹĺ [symbol] L′l′L⋅8l [symbol] Ńń [symbol] Ňň′n [symbol] ŌōŎŏ9Őő [symbol] Ŕŕ [symbol] ŘřŚśŞşΨŠšŢţŤ\acute{t} [symbol] ŨũŪūŬŭŮů [symbol] ŰűU̧u̧ŴŵŶŷŸŹźŻżŽž [symbol] ĆćÐ [symbol] [symbol] [symbol] [symbol] [symbol] Σ [symbol] U′u′Ω [symbol] Y”

A byte length after encoding is 236, with encoded content includes “3ğǵćĊīðýč5ăJ̧ćîēĭìĭĥĭġ [symbol] ĈîÿÐñôġýēýa̧iñġĊ3āĤ [symbol] ĨĎ5 [symbol] a̧ĔĆèòĎè6òiĨĥĪǵĞìĜ7ïóčj̧èĩôīñiěĩ\check{I}čÐĒĨĒĠ\dot{i}îĒ5čĆ4İĀĆ [symbol] ĞĨℏǵĝčćÐĒĝ\check{a}Ćj̧ăċĀô6Ēj̧òýĀ55ôċčǵĎē7ïěĪĤěēĞĬĩóĊĀĬÿIJiĝℏÐĪìīôāóīġċĊóÐA̧Č [symbol] Ďèïİİēēĉč [symbol] j̧íìA̧ÿĝñĉðēĆČ\check{g}iĎİĊāćĭíĂĔĪĜāčï7 [symbol] ĪiīõèÐĉĞīĎíĝēīèýĬè3 [symbol] ē6d′ [symbol] 7ÿġÿčèìāðè67ù”.

As can be seen, a byte length using a dictionary for encoding is the same as a byte length of an array before encoding, which is a number of 236 bytes. In other words, the byte length after encoding is not increased, and is the same as the byte length before encoding. Therefore, information content of a message can be converted into a text that is transmissible by a message without increasing a data length, thus achieving the goal of transmitting complicated communication information content.

Using the above operations, information content of a message to be sent is converted into byte data. Based on mapping relationships between predetermined byte data and predetermined characters in a pre-stored character set, character data corresponding to the byte data, which has been converted from the information content, is found from the pre-stored character set. This character data is then sent out by means of messaging. Therefore, under a condition that a data length is not increased, the byte data which has been converted from the information content is converted into a text that is transmissible by a message, thus improving the goal of transmitting information content of complex communications. This thereby solves the technical problems of limited areas of use of messages due to a length limitation for content in the messages, and expands the areas of use of the messages.

In implementations, prior to S204, the method further includes encrypting the elements in the byte array.

It should be noted that the elements in the byte array can be encrypted using an AES algorithm. The AES algorithm is an algorithm in existing technologies, and is not described in detail herein. After encryption by the AES algorithm, a length of the byte array is increased by a certain extent. In implementations, a 128-bit encryption may be used, and the encrypted byte array may be increased by a certain degree. However, the embodiments of the present disclosure can shorten a length of information content of a message that is to be sent during transmission by encrypting a byte array, and therefore can perform encryption on information of the message to ensure the security of the information content of the message during transmission.

It should be noted that the embodiments of the present disclosure are mainly used for solving a situation when a length of a byte array is less than a length of a message and the length thereof exceeds the length of the message after going through conventional coding such as base64. The embodiments of the present disclosure perform coding using the pre-stored character set as described above, rather than using conventional coding. This allows the byte array to become a text transmissible by a message without changing a data length thereof, and thus transmission can be performed through a message.

In order to understand the present disclosure in a better manner, the above embodiments of the present disclosure are described in further detail in conjunction with exemplary embodiments.

The exemplary embodiments provided by the embodiments of the present disclosure perform processing such as simplification, encryption, coding, etc., on data, and can send the processed content through messaging.

Before using the exemplary embodiments of the present disclosure, a character dictionary is needed to be generated and used. The character dictionary is an original creation of the embodiments of the present application, and is a key for solving byte data sent by a message.

A method of generating the above character dictionary is to randomly select 256 non-duplicate characters from a character set that is allowable for messages to generate a dictionary, which corresponds to a range that can be represented by a byte. For example, a dictionary that is generated by randomly selecting 256 non-duplicate characters from a character set that is allowable for messages includes: “ [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] ”.

A method of using the above character dictionary is to traverse a byte array and search a character dictionary based on values in the byte array to generate a character string, and to restore an original byte array based on the character string and the same character dictionary when decoding.

For example, after coding, a byte array of 64 bytes is converted into “ [symbol] [symbol] [symbol] [symbol] [symbol] [symbol] [symbol] [symbol] [symbol] ”. A length thereof is not increased, and can be sent through messaging.

A process of message processing is described below, and includes the following operations.

S2032: Simplification

Original data: [command=5, cmdid=48000000, timestamp=1418269187005, imei=863121027176726, pwd=123456, data1=1418269187005, data2=1418269187005, data3=1418269187005], with a length of 142.

The original data is simplified as [5, 123456, 48000000, 1418269187005, 863121027176726, 1418269187005, 1418269187005, 1418269187005]. Data models of the array can be adjusted according to data lengths. Therefore, the data models of the array can be further limited to [byte, int, long, long, long, long, long, long].

After simplification, data that needs 142 characters for representation, can now be represented by only 53 bytes. Thus, the above data is changed into a byte array having a length of 53.

S2034: Encryption

Encryption is performed on data of the simplified byte array using AES. Based on a selection of the AES algorithm, a length thereof is increased a little bit. In an application, 128-bit encryption is generally used. The length of the byte array is changed from 53 to 64.

S2036: Coding

The byte array of 64 bytes will become messy code, and cannot be recognized in a message if being directly converted into a string. After using the commonly used base64 for coding, a data length will increase, and 64 bytes of data will become 90 bytes, which exceeds a length that can be transmitted in a single message.

However, coding using the character dictionary described in the exemplary embodiments of the present disclosure can change data into a text transmissible in a message without changing a length of the data.

According to the exemplary embodiments of the present disclosure, each data packet can transmit a size up to 53 bytes (based on different encryption methods are used, this length can be changed, and the maximum does not exceed 70). Within this length, a more complex communication can be completed by self-defining a format through negotiation.

It should be noted that the foregoing method embodiments are described in a series of combinations of actions for the sake of description. The present disclosure is not limited to an order of actions described, because certain operations can be performed in other orders or in parallel according to the present disclosure. Furthermore, one skilled in the art can also understand that the embodiments described in the specification are exemplary embodiments. Actions and modules involved therein are not essential to the present disclosure

Through the description of the above implementations, one of ordinary skill in the art can clearly understand that the embodiments of the message sending method can be implemented using software with necessary universal hardware platform(s), or apparently using hardware. However, the former one is a better implementation under a number of situations. Based on this understanding, the essence of the technical solutions of the present disclosure or the portions that provide contribution to the existing technologies can be implemented in a form of a software product. The computer software product is stored in a storage media (such as ROM/RAM, a magnetic disk, an optical drive), which includes instructions for causing a terminal device (which may be a mobile phone, a computer, a server, or a network device, etc.) to perform the method described in various embodiments of the present disclosure.

### Second Embodiment

According to the embodiments of the present disclosure, an exemplary message receiving method is provided. It should be noted that operations shown in a flowchart of an accompanying drawing can be executed in a computing system having computer-executable instructions. Moreover, although a flowchart shows a logical order, operations can be executed in an order different from the one as shown or described herein.

The exemplary method provided by the second embodiment of the present disclosure can be executed in a mobile terminal, a computing terminal or a similar computing apparatus. A computing terminal is used as an example, which can be implemented using a hardware structural block diagram of a computing terminal as shown in FIG. 1.

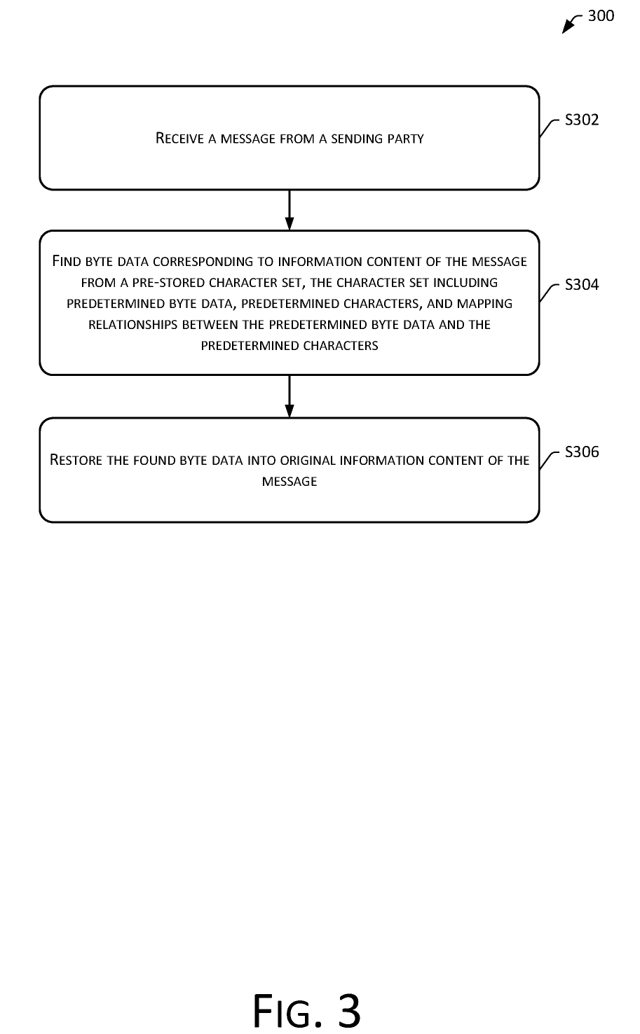

Under the above running environment, the present disclosure provides a message receiving method 300 as shown in FIG. 3. FIG. 3 is a flowchart of a message receiving method 300 in accordance with the second embodiment of the present disclosure. As shown in FIG. 3, the method 300 includes the following operations.

S302 receives a message from a sending party.

It should be noted that the message can be a message sent in the first embodiment. A representation of the message can be character data that has been coded using a pre-stored character set, or character data that has been simplified, encrypted and coded using a pre-stored character set, which is not limited therein.

S304 finds byte data corresponding to information content of the message from a pre-stored character set, the character set including predetermined byte data, predetermined characters, and mapping relationships between the predetermined byte data and the predetermined characters.

The pre-stored character set can be determined through the following approach: selecting a predetermined number of characters from a character set that is supported by messages according to predetermined rule(s), the selected characters being not duplicated; and establishing mapping relationships between various pieces of byte data and the predetermined number of the selected characters. The character set that is supported by the messages may be a character set that supports transmission of Unicode. Furthermore, selecting the predetermined number of characters from the character set can be a selection according to certain rule(s), or can be a random selection, provided that the selected characters of the predetermined number are not duplicated. In implementations, the predetermined number may be 256, i.e., a range that can be represented by one byte.

For example, 256 non-duplicate characters are selected from an Unicode character set to obtain a pre-stored character set as [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] . [symbol] [symbol] [symbol] [symbol] [symbol] [symbol] [symbol] . Mapping relationships between respective positions or sequence numbers of characters in the pre-stored character set and the characters can be mapping relationships between various pieces of byte data and the predetermined number of selected characters, which is not limited herein.

In implementations, S304 may include finding byte array corresponding to information content from a pre-stored character set, wherein elements in the byte array are determined based on values of a character string, and the character string is used for representing original information content of the message.

S306 restores the found byte data into original information content of the message.

The above pre-stored character set is used as an example. If character data of the message that is received is: [symbol] [symbol] [symbol] , a message receiving method can be expressed as to find a sequence number or position of each character in the character data in the pre-stored character set from the pre-stored character set. Finding a sequence number of each character in character data in the pre-stored character set is used as an example. A result of finding the above character data is byte data is [114,86,50,67,88,81,54,78,68,65,66,104,114,71,108,76,106,102,99,86,51,103,61,61]. Original data corresponding to this byte data is {pwd=12345}. As such, original information content of the message is restored.

Using the above operations, byte data corresponding to information content of the message is found from the pre-stored character set based on mapping relationships between predetermined byte data and predetermined characters in the pre-stored character set. The found byte data is then restored into original information content of the message. Decoding using the pre-stored character set is performed on the message that has been coded using the pre-stored character set, to store the original information content of the message, thus achieving the goal of transmitting information content of complicated communication, solving the technical problems of limited areas of use of messages due to a length limitation for content in the messages, and expands the areas of use of the messages.

In the exemplary embodiments of the present disclosure, if the message has been encrypted when sending, the method further includes decrypting the found byte data in the pre-stored character set to obtain byte array corresponding to the information content.

In order to understand the present disclosure in a better manner, the foregoing embodiments of the present disclosure are described in further detail in conjunction with the exemplary embodiments.

S2032-S2036 of the exemplary embodiments of the message sending method in the first embodiment are used as an example. After a message is sent out through S2032-S2036 and after a receiving party receives the message, a same dictionary (i.e., a character dictionary of the present exemplary embodiment) in the exemplary embodiments of the first embodiment is used for decoding each piece of byte data to obtain encrypted data body. The data body is then decrypted to obtain content of a data packet.

It should be noted that the foregoing method embodiments are described in a series of combinations of actions for the sake of description. The present disclosure is not limited to an order of actions described, because certain operations can be performed in other orders or in parallel according to the present disclosure. Furthermore, one skilled in the art can also understand that the embodiments described in the specification are exemplary embodiments. Actions and modules involved therein are not essential to the present disclosure

Through the description of the above implementations, one of ordinary skill in the art can clearly understand that the embodiments of the message sending method can be implemented using software with necessary universal hardware platform(s), or apparently using hardware. However, the former one is a better implementation under a number of situations. Based on this understanding, the essence of the technical solutions of the present disclosure or the portions that provide contribution to the existing technologies can be implemented in a form of a software product. The computer software product is stored in a storage media (such as ROM/RAM, a magnetic disk, an optical drive), which includes instructions for causing a terminal device (which may be a mobile phone, a computer, a server, or a network device, etc.) to perform the method described in various embodiments of the present disclosure.

### Third Embodiment

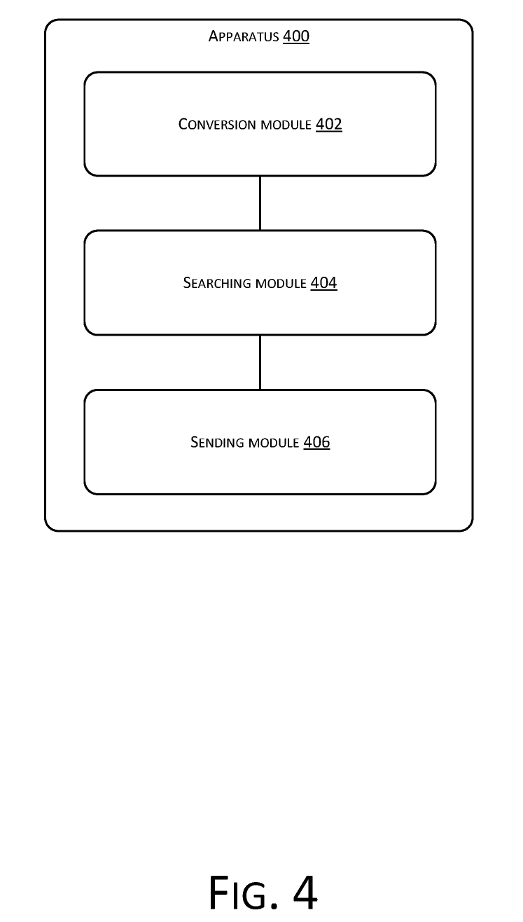

According to the embodiments of the present disclosure, an apparatus used for implementing the message sending method of the first embodiment is further provided. FIG. 4 is a first structural block diagram of a message sending apparatus 400 in accordance with the embodiments of the present disclosure. As shown in FIG. 4, the apparatus 400 includes a conversion module 402 used for converting information content of a message into byte data.

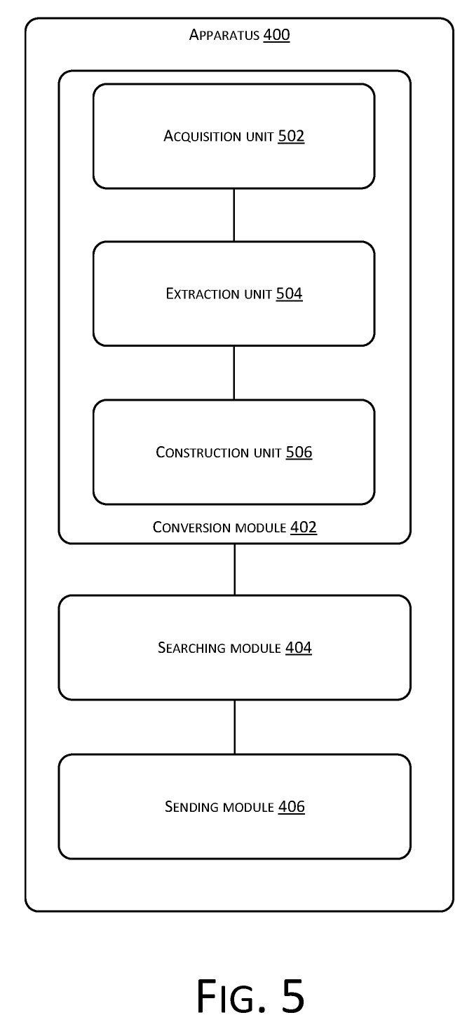

FIG. 5 is a second structural block diagram of the message sending apparatus 400 in accordance with the embodiments of the present disclosure. As shown in FIG. 5, in implementations, the conversion module 402 includes an acquisition unit 502 used for obtaining a character string corresponding to the information content; an extraction unit 504, coupled with the acquisition unit 502, used for extracting values of the character string; and a construction unit 506, coupled with the extraction unit 504, used for using the extracted values as elements of an array to form a byte array, and using elements of the byte array as byte data. By using the conversion module 402 to extract values of a character string corresponding to the information content for simplifying the character string and generating a byte array, a length of information content that needs to be sent is reduced by a certain extent. It should be noted that if information content of a message to be sent is not simplified and does not exceed a length that can be sent by a single message after going through conventional coding or coding using a pre-stored character set as described below, this simplification process may not need to be performed, and the information content can be directly converted into byte data. Therefore, the above extraction module 4024 is optional.

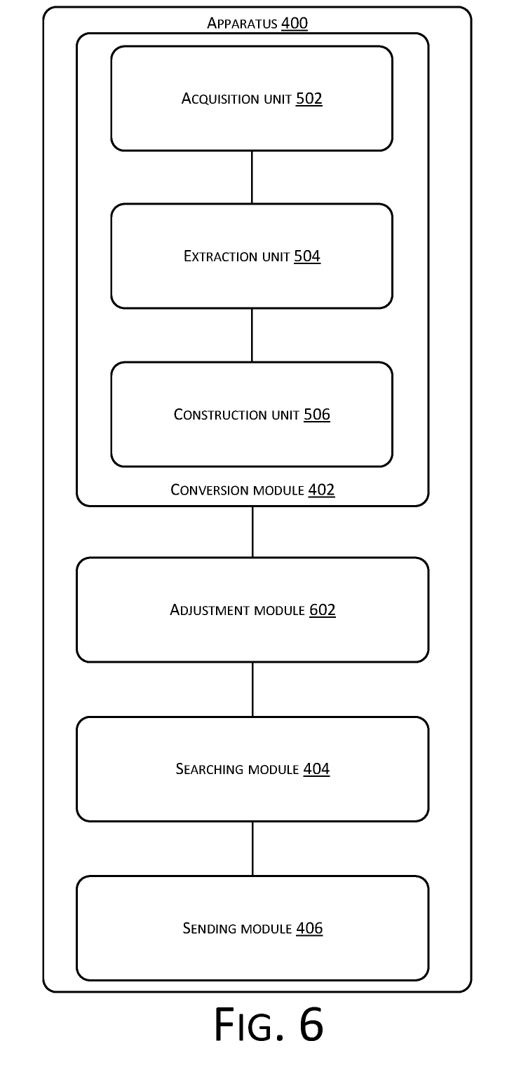

Data models of the elements in the byte array can be adaptively defined. FIG. 6 is a third structural block diagram of the message sending apparatus 400 in accordance with the embodiments of the present disclosure. As shown in FIG. 6, in implementations, the above apparatus 400 further includes an adjustment module 602, coupled with the conversion module 402, used for adjusting data models of the elements according to respective byte lengths of the elements in the byte array, wherein different data models have different byte lengths. Number of bytes needed by the byte array can be reduced using the above method of adaptively defining data models in byte data.

In implementations, the adjustment module 62 is coupled with the construction unit 506 in the conversion module 402.

“[command=5, cmdid=48000000, timestamp=1418269187005, imei=863121027176726, pwd=123456, data1=1418269187005, data2=1418269187005, data3=1418269187005]” is used as an example of a character string corresponding to information content of a message. A length of this character string is 142 characters. In a specific embodiment, the extraction unit 504 extracts values from the character string, and an array that is obtained is [5, 48000000, 1418269187005, 863121027176726, 123456, 1418269187005, 1418269187005, 1418269187005]. Based on data lengths of elements in this array, the adjustment module 62 can adapt respective data models of the elements. For example, the first element is 5. As such, only one byte is needed for representation. Therefore, a data model of this first element can be limited as a byte type, without the need of limiting the data model as an int type or a long type. For other elements, a similar approach can be used for adaptively defining data models of these elements. For the above array, respective data models of the elements of the array obtained by adaptively defining the data models are [byte, long, long, long, int, long, long, long] respectively. As can be seen, this array can be represented by 53 bytes only. As can be seen, through the foregoing implementations, data that originally needs 142 characters for representation can be represented by 53 characters only through the above processing method. Furthermore, the above data becomes a byte array of a length of 53.

A searching module 404 is coupled with the conversion module 402, and is used for searching for characters corresponding to the byte data from a pre-stored character set to obtain character data, wherein the character set includes predetermined byte data, predetermined characters, and mapping relationships between the predetermined byte data and the predetermined characters, and the predetermined characters are characters supported by messages.

The pre-stored character set can be determined through the following approach: selecting a predetermined number of characters from a character set that is supported by messages according to predetermined rule(s), the selected characters being not duplicated; and establishing mapping relationships between various pieces of byte data and the predetermined number of the selected characters. The character set that is supported by the messages may be a character set that supports transmission of Unicode. Furthermore, selecting the predetermined number of characters from the character set can be a selection according to certain rule(s), or can be a random selection, provided that the selected characters of the predetermined number are not duplicated. In implementations, the predetermined number may be 256, i.e., a range that can be represented by one byte.

For example, 256 non-duplicate characters are selected from an Unicode character set to obtain a pre-stored character set as [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] .

Mapping relationships between respective positions or sequence numbers of characters in the pre-stored character set and the characters can be mapping relationships between various pieces of byte data and the predetermined number of selected characters, which is not limited herein.

A sending module 406 is used for sending the character data through messaging.

{pwd=12345} is used as an example of data corresponding to information content of a message that is sent by the apparatus, which is converted into such a byte array, for example, [114,86,50,67,88,81,54,78,68,65,66,104,114,71,108,76,106,102,99,86,51,103,61,61], by the conversion module 402. If content of this byte array is treated as a string for transmission, a length thereof is 80, longer than a message. Using the above example method, if the pre-stored character set is the character set that is predetermined in the above embodiment, by corresponding a value of each byte in the byte array to a character in the pre-stored character set as described above, the byte array is changed into: [symbol] [symbol] [symbol] [symbol] , with a length of 24, after coding. Character data that is obtained is: [symbol] [symbol] [symbol] . Therefore, in implementations, a length of content of a message that is sent by messaging is greatly reduced by using a pre-stored character set for coding. The degree of complexity of the information content is thus increased, expanding the usage scope of the message.

Using the above modules in the apparatus, byte data that is converted from information content of a message is converted into a text that is transmissible by the message, without increasing a data length, thus improving the goal of transmitting information content of complex communications. This thereby solves the technical problems of limited areas of use of messages due to a length limitation for content in the messages, and expands the areas of use of the messages.

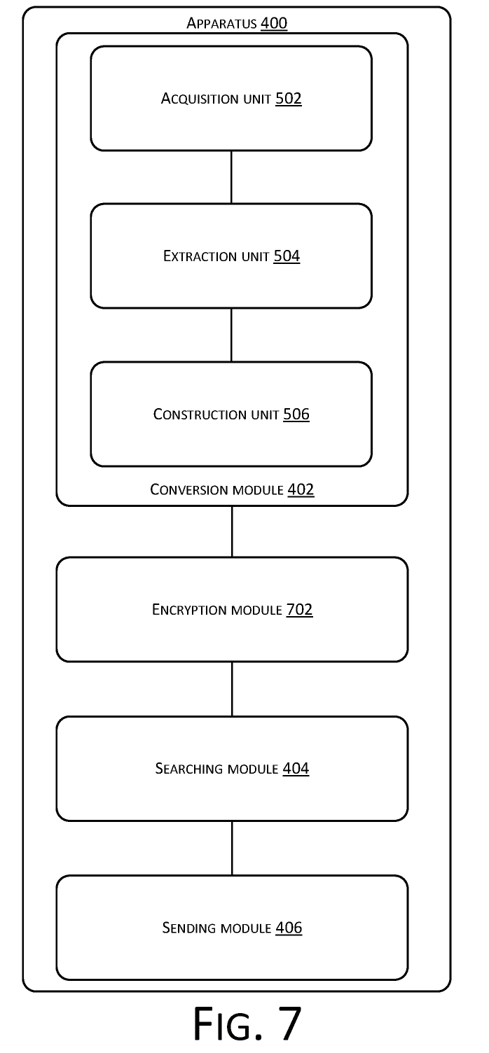

FIG. 7 is a fourth structural block diagram of the message sending apparatus 400 in accordance with the embodiments of the present disclosure. As shown in FIG. 7, the above apparatus 400 further includes an encryption module 702, which is coupled with the conversion module 402, used for encrypting the elements in the byte array. It should be noted that the encryption module 702 can encrypt the elements in the byte array using an AES algorithm. The AES algorithm is an algorithm in existing technologies, and is not described in detail herein. After encryption by the AES algorithm, a length of the byte array is increased by a certain extent. In implementations, a 128-bit encryption may be used, and the encrypted byte array may be increased by a certain degree. However, the embodiments of the present disclosure can shorten a length of information content of a message that is to be sent during transmission by encrypting a byte array, and therefore can perform encryption on information of the message to ensure the security of the information content of the message during transmission.

It should be noted that the embodiments of the present disclosure are mainly used for solving a situation when a length of a byte array is less than a length of a message and the length thereof exceeds the length of the message after going through conventional coding such as base64. The embodiments of the present disclosure perform coding using the pre-stored character set as described above, rather than using conventional coding. This allows the byte array to become a text transmissible by a message without changing a data length thereof, and thus transmission can be performed through a message.

### Fourth Embodiment

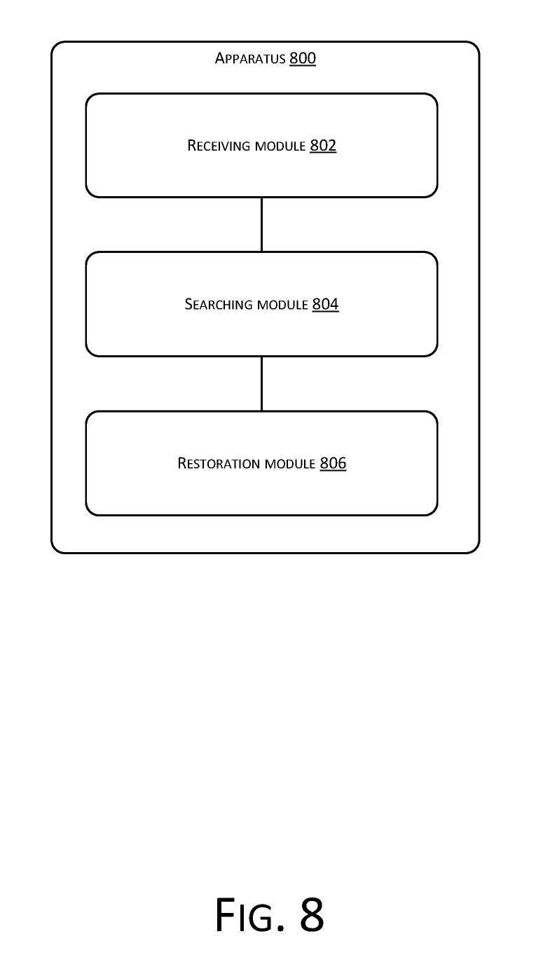

According to the embodiments of the present disclosure, an apparatus used for implementing the message receiving method of the second embodiment is further provided. FIG. 8 is a first structural block diagram of a message receiving apparatus 800 in accordance with the embodiments of the present disclosure. As shown in FIG. 8, the apparatus 800 includes a receiving module 802 used for receiving a message from a sending party.

It should be noted that the message can be a message sent in the first embodiment. A representation of the message can be character data that has been coded using a pre-stored character set, or character data that has been simplified, encrypted and coded using a pre-stored character set, which is not limited therein.

A searching module 804 is coupled with the receiving module 802, and is used for finding byte data corresponding to information content of the message from a pre-stored character set, the character set including predetermined byte data, predetermined characters, and mapping relationships between the predetermined byte data and the predetermined characters.

The pre-stored character set can be determined through the following approach: selecting a predetermined number of characters from a character set that is supported by messages according to predetermined rule(s), the selected characters being not duplicated; and establishing mapping relationships between various pieces of byte data and the predetermined number of the selected characters. The character set that is supported by the messages may be a character set that supports transmission of Unicode. Furthermore, selecting the predetermined number of characters from the character set can be a selection according to certain rule(s), or can be a random selection, provided that the selected characters of the predetermined number are not duplicated. In implementations, the predetermined number may be 256, i.e., a range that can be represented by one byte.

For example, 256 non-duplicate characters are selected from an Unicode character set to obtain a pre-stored character set as [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] .

Mapping relationships between respective positions or sequence numbers of characters in the pre-stored character set and the characters can be mapping relationships between various pieces of byte data and the predetermined number of selected characters, which is not limited herein.

The searching module 804 is further used for finding byte array corresponding to the information content from the pre-stored character set, wherein elements in the byte array are determined based on values of a character string, and the character string is used for representing original information content of the message.

A restoration module 806 is coupled with the searching module 804, and is used for restoring the found byte data into original information content of the message.

The above pre-stored character set is used as an example. If character data of the message received by the receiving module 802 in the receiving apparatus is: [symbol] [symbol] [symbol] , the searching module 804 finds a sequence number or position of each character in the character data in the pre-stored character set from the pre-stored character set. Finding a sequence number of each character in character data in the pre-stored character set is used as an example. A result of finding the above character data is byte data is [114,86,50,67,88,81,54,78,68,65,66,104,114,71,108,76,106,102,99,86,51,103,61,61]. The restoration module 806 restores this byte data to original data as {pwd=12345}. As such, original information content of the message is restored.

Using the above apparatus, byte data corresponding to information content of the message is found from the pre-stored character set based on mapping relationships between predetermined byte data and predetermined characters in the pre-stored character set. The found byte data is then restored into original information content of the message. Decoding using the pre-stored character set is performed on the message that has been coded using the pre-stored character set, to store the original information content of the message, thus achieving the goal of transmitting information content of complicated communication, solving the technical problems of limited areas of use of messages due to a length limitation for content in the messages, and expands the areas of use of the messages.

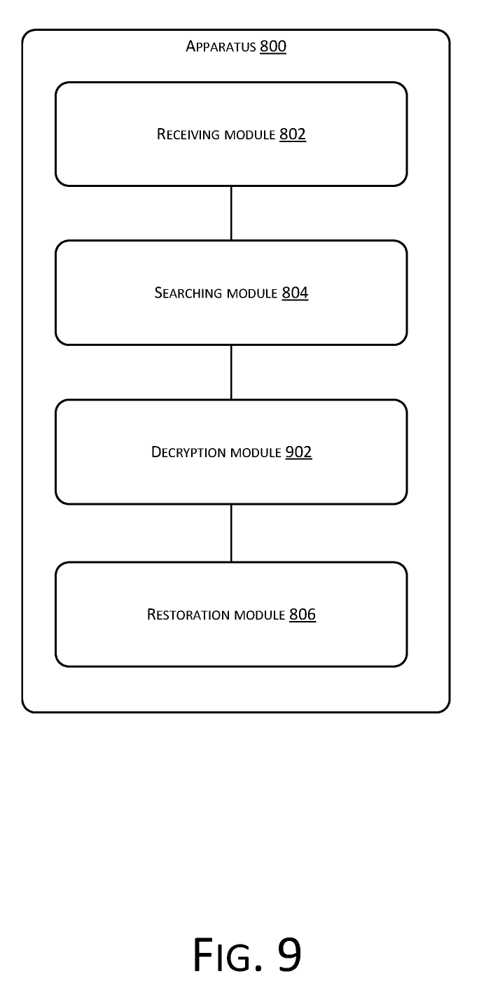

FIG. 9 is a second structural block diagram of the message receiving apparatus 800 in accordance with an embodiment of the present disclosure. As shown in FIG. 9. The above apparatus 800 further includes a decryption module 902, coupled with the searching module 804, used for decrypting the found byte data in the pre-stored character set to obtain the byte array corresponding to the information content. It should be noted that the process of decryption is a reverse process of the process of encryption when a message is sent. When a message is encrypted when being sent, and therefore needs to be decrypted when being received. If encryption is not performed when sending, decryption does not need to be performed when receiving. Therefore, this decryption module is optional.

### Fifth Embodiment

The embodiments of the present disclosure can provide a computing terminal. The computing terminal can be any one computing terminal in a group of computing terminals. Optionally, in the present embodiment, the computing terminal may also be substituted by a terminal device such as a mobile terminal.

Optionally, in the present embodiment, the computing terminal may be at least one network device in a plurality of network devices of a computer network.

In the present embodiment, the computing terminal can execute the following operations of program codes in an application program for a message sending method: converting information content of a message to be sent into byte data; searching for characters corresponding to the byte data from a pre-stored character set to obtain character data, wherein the character set includes predetermined byte data, predetermined characters, and mapping relationships between the predetermined byte data and the predetermined characters, and the predetermined characters are characters that are supported by messages; and sending the character data by means of messaging.

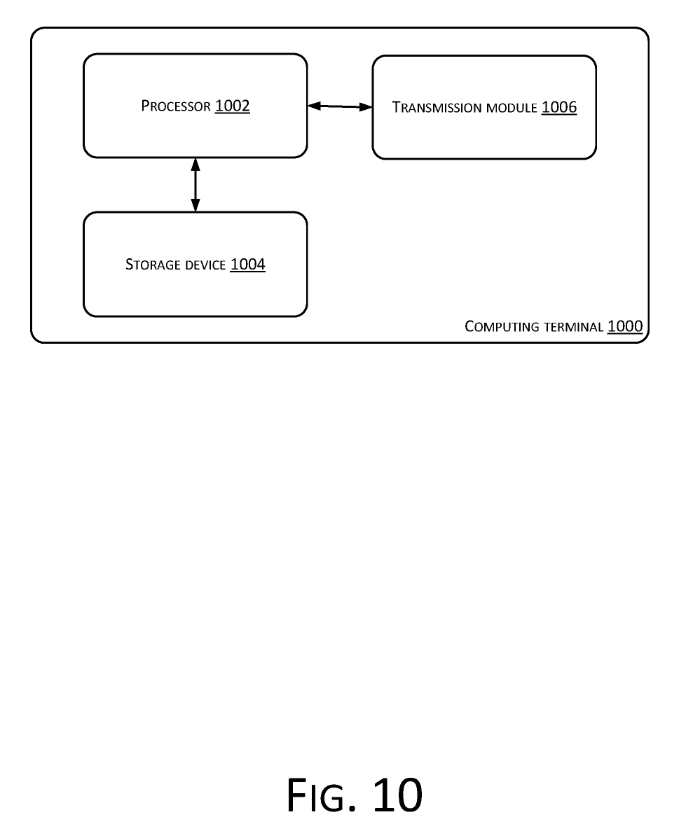

Optionally, FIG. 10 is a structural diagram of a computing terminal 1000 in accordance with the fifth embodiment of the present disclosure. As shown in FIG. 10, the computing terminal 1000 may include one or more processors 1002, a storage device 1004, and a transmission module 1006.

The storage device 1004 can be used for storing software programs or modules of software, such as program instructions/modules corresponding to a message sending method of the embodiments of the present disclosure. The processors 1002 executes various functional applications and data processing by running software program(s) and module(s) stored in the storage device 1004, i.e., implementing the message sending method of the above software program. The storage device 1004 may include a high-speed random access memory, and may also include non-volatile memory, such as one or more magnetic storage apparatus, flash storage, or other non-volatile solid state memory. In some embodiments, the storage device 1004 may further include remotely configured storage devices corresponding to the processors 1002. These remote storage devices may be connected to the computing terminal 10 through a network. Examples of the network include, but are not limited to, the Internet, an intranet, a local area network, a mobile communication network, or a combination thereof.

The transmission module 1006 is used for receiving or sending data through a network. Examples of the network may include a wired network and a wireless network. In an embodiment, the transmission module 1006 includes a network interface controller (NIC), which can conduct communications with the Internet or a local area network by connecting with routers via network cables and other network devices. In an embodiment, the transmission module 1006 may be a radio frequency (RF) module, which is used for conducting communications with the Internet through a wireless method.

The storage device 1004 is used for storing information of predetermined action requirements and predetermined privilege users, and application programs. For example, the storage device 1004 is used for storing program codes that implement the following operations: obtaining a character string corresponding to information content; extracting values of the character string; and using the extracted values as elements of an array to construct a byte array, and using elements in the byte array as byte data. Optionally, the storage device 103 is further used for storing program codes that implement the following operations: adjusting data models of the elements according to respective byte length of the elements in the byte array, wherein different data models have different byte lengths.

Using the embodiments of the present disclosure, a solution for a computing terminal that can execute the message sending method is provided. Information content of a message to be sent is converted into byte data. Based on mapping relationships between predetermined byte data and predetermined characters in a pre-stored character set, character data corresponding to the byte data, which has been converted from the information content, is found from the pre-stored character set. This character data is then sent out by means of messaging. Therefore, under a condition that data length is not increased, the byte data which has been converted from the information content is converted into a text that is transmissible by a message, thus improving the goal of transmitting information content of complex communications. This thereby solves the technical problems of limited areas of use of messages due to a length limitation for content in the messages, and expands the areas of use of the messages.

One of ordinary skill in the art can understand that the structure shown in FIG. 10 is merely illustrative. The computing terminal can also be a terminal device such as a smart phone (e.g., Android phone, iOS phone, etc.), a tablet computer, a handheld computer, and a mobile Internet device (MID), etc. FIG. 10 does not impose any limitation on the structure of the above electronic apparatus. For example, the computing terminal A may also include more or fewer components (such as a network interface, a display device, etc.) shown in FIG. 10, or have a configuration different from the one shown in FIG. 10.

One of ordinary skill in the art can understand that all or some of the operations in the methods of the embodiments can be completed by instructing related hardware of a terminal device through a program. The program can be stored in a computer-readable storage media. The storage media may include a flash drive, a read-only memory (ROM), a random access memory (RAM), a magnetic disk, or an optical drive, etc.

### Sixth Embodiment

The embodiments of the present disclosure can provide computing terminal. The computing terminal can be any one computing terminal in a group of computing terminals. Optionally, in the present embodiment, the computing terminal may also be substituted by a terminal device such as a mobile terminal.

Optionally, in the present embodiment, the computing terminal may be at least one network device in a plurality of network devices of a computer network.

In the present embodiment, the computing terminal can execute the following operations of program codes in an application program for a message receiving method: receiving a message from a sending party; finding character data corresponding to information content of the message from a pre-stored character set, the character set includes predetermined byte data, predetermined characters, and mapping relationships between the predetermined byte data and the predetermined characters; and restoring the found character data to original information content of the message.

It should be noted that the structure of the computing terminal in this embodiment of the present disclosure may be the same as or different from the computing terminal in the fifth embodiment. For example, the transmission module 1006 in the fifth embodiment may be used for implementation of receiving a message. Alternatively, an independent receiving module that is separate from the transmission module 1006 may be set up. However, the computing terminal in the fifth embodiment is used for executing program codes for operations of a message sending method, while the computing terminal in the present embodiment is used for executing program codes for operations of a message receiving method.

Optionally, the storage device 1004 may further store program codes for the following operations: finding a byte array corresponding to the information content from the pre-stored character set, wherein elements in the byte array are determined based on values of a character string, and the character string is used for representing the original information content of the message.

Using the embodiments of the present disclosure, a solution for a computing terminal that can execute the message receiving method is provided. Based on mapping relationships between predetermined byte data and predetermined characters in a pre-stored character set, byte data corresponding to information content of a message is found from the pre-stored character set. The found byte data is then restored into original information content of the message. Decoding using the pre-stored character set is performed on the message that has been coded using the pre-stored character set, to store the original information content of the message, thus achieving the goal of transmitting information content of complicated communication, solving the technical problems of limited areas of use of messages due to a length limitation for content in the messages, and expands the areas of use of the messages.

### Seventh Embodiment

The embodiments of the present disclosure also provide a storage media. Optionally, in the present embodiment, the storage media may be used for storing program codes that are executed by the message sending method provided in the first embodiment.

Optionally, in the present embodiment, the storage media may be located in any one computing terminal in a group of computing terminals in a computer network, or located in any one mobile terminal in a group of mobile terminals.

Optionally, in the present embodiment, the storage media is configured to store program codes that execute the following operations: converting information content of a message to be sent into byte data; searching for characters corresponding to the byte data from a pre-stored character set to obtain character data, wherein the character set includes predetermined byte data, predetermined characters, and mapping relationships between the predetermined byte data and the predetermined characters, and the predetermined characters are characters that are supported by messages; and sending the character data by means of messaging.

It should be noted herein that the any one computing terminal in the group of computing terminals as described the above can establish a communication relationship with a network server and a scanning device. The scanning device can scan a value command of a web application program that is executed by php in the computing terminal.

### Eighth Embodiment

The embodiments of the present disclosure also provide a storage media. Optionally, in the present embodiment, the storage media may be used for storing program codes that are executed by the message receiving method provided in the second embodiment.

Optionally, in the present embodiment, the storage media may be located in any one computing terminal in a group of computing terminals in a computer network, or located in any one mobile terminal in a group of mobile terminals.

Optionally, in the present embodiment, the storage media is configured to store program codes that execute the following operations: receiving a message from a sending party; finding character data corresponding to information content of the message from a pre-stored character set, the character set includes predetermined byte data, predetermined characters, and mapping relationships between the predetermined byte data and the predetermined characters; and restoring the found character data to original information content of the message.

It should be noted herein that the any one computing terminal in the group of computing terminals as described the above can establish a communication relationship with a network server and a scanning device. The scanning device can scan a value command of a web application program that is executed by php in the computing terminal.

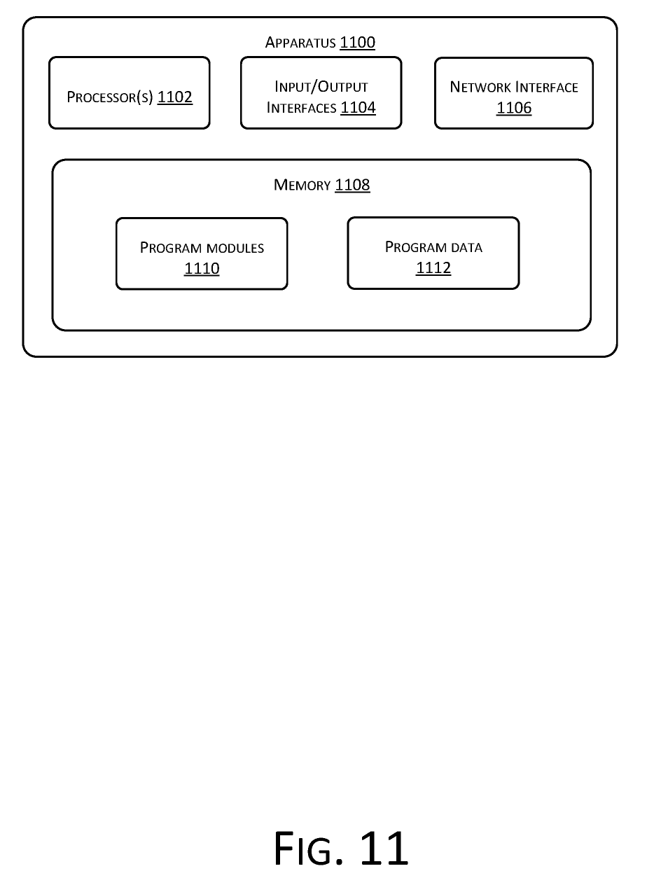

FIG. 11 is a structural block diagram of an exemplary apparatus 1100, such as the message sending apparatus 400 or the message receiving apparatus 800 as described in the foregoing embodiments, in further detail. The apparatus 1100 may include one or more processors 1102, an input/output (I/O) interface 1104, a network interface 1106, and memory 1108.

The memory 1108 may include a form of computer readable media such as a volatile memory, a random access memory (RAM) and/or a non-volatile memory, for example, a read-only memory (ROM) or a flash RAM. The memory 1108 is an example of a computer readable media.

The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In implementations, the memory 1108 may include program modules 1110 and program data 1112. Depending on which apparatus (such as the message sending apparatus 400 or the message receiving apparatus 800) the apparatus 1100 is representing, the program modules 1110 may include one or more of the foregoing units as described above.

Sequence numbers of the embodiments of the present disclosure described above are merely for the purpose of description, and do not represent the qualities of the embodiments.

In the foregoing embodiments of the present disclosure, the description of each embodiment has its own emphasis, and a portion that is not described in detail in a certain embodiment can be referenced to related descriptions of other embodiments.

In the embodiments provided in the present disclosure, it can be understood that the disclosed client can be implemented in other manners. The foregoing apparatus embodiments are merely illustrative. For example, a division between the units is merely a division of logical functions. Another way of division may exist in practice. For example, multiple units or components may be combined or may be integrated into another system, or some features may be ignored or not be executed. Moreover, mutual coupling, direct coupling, or communication connection that is shown or discussed can go through some interfaces. Coupling or communication connection between units or modules can be in electrical or other forms.

Units that are described as separate components may or may not be physical separated from each other. A unit, which is shown as a component, may or may not be a physical unit, i.e., may be located in one place, or may be distributed among multiple network units. Some or all of the units can be selected to implement the goal of the solutions of the present embodiments based on actual requirements.

Furthermore, various functional units in the embodiments of the present disclosure can be integrated as a single processing unit, or can exist as physically independent units. Alternatively, two or more than two units can be integrated as a single unit. The above integrated unit can be implemented in a form of hardware, or can be implemented in a form of software.

If being implemented as a software functional unit and sold or used as an independent product, the integrated unit can be stored in a computer-readable storage media. Based on this understanding, the essence of the technical solutions of the present disclosure or the portions that provide contribution to the existing technologies or all or some portions of the technical solutions can be implemented in a form of a software product. The computer software product is stored in a storage media which includes instructions for causing a terminal device (which may be a personal computer, a server, or a network device, etc.) to perform some or all of the operations of the method described in various embodiments of the present disclosure. The storage media includes various media that can store program codes such as U disk, a read-only memory (ROM), a random access memory (RAM), a movable drive, a magnetic disk, or an optical drive.

The exemplary embodiments of the present disclosure are described above. It should be noted that one of ordinary skill in the art can also make various improvements and polishing without departing the principles of the present disclosure. These improvements and polishing shall fall within the scope of protection of the present disclosure.

1. A method comprising:
converting information content of a message to be sent into byte data;
searching for characters corresponding to the byte data from a pre-stored character set to obtain character data, wherein the character set includes predetermined byte data, predetermined characters, and mapping relationships between the predetermined byte data and the predetermined characters, and the predetermined characters are characters that are supported by messages; and
sending the character data through messaging.

2. The method of claim 1, wherein the pre-stored character set is determined by:
selecting a predetermined number of characters from a character set that is supported by messages according to a predetermined rule, the selected characters being not duplicated; and
establishing mapping relationships between various pieces of byte data and the predetermined number of the selected characters.

3. The method of claim 2, wherein the predetermined number is 256.

4. The method of claim 1, wherein converting the information content of the message to be sent into the byte data comprises:
obtaining a character string corresponding to information content;
extracting values of the character string; and
using the extracted values as array elements to construct a byte array, and using elements of the byte array as byte data.

5. The method of claim 4, wherein prior to searching for the characters corresponding to the byte data from the pre-stored character set, the method further comprises adjusting data models of the elements according to respective byte lengths of the elements in the byte array, wherein different data models have different byte lengths.

6. The method of claim 5, wherein the data models of the elements comprise at least one of a byte type, an int type, or a long type.

7. The method of claim 4, wherein prior to searching for the characters corresponding to the byte data from the pre-stored character set, the method further comprises encrypting the elements in the byte array.

8. The method of claim 7, wherein the elements in the byte array are encrypted using an AES algorithm.

9. One or more computer-readable media storing executable instructions that, when executed by one or more processors, cause the one or more processors to perform acts comprising:
converting information content of a message to be sent into byte data;
searching for characters corresponding to the byte data from a pre-stored character set to obtain character data, wherein the character set includes predetermined byte data, predetermined characters, and mapping relationships between the predetermined byte data and the predetermined characters, and the predetermined characters are characters that are supported by messages; and
sending the character data through messaging.

10. The one or more computer-readable media of claim 9, wherein the pre-stored character set is determined by:
selecting a predetermined number of characters from a character set that is supported by messages according to a predetermined rule, the selected characters being not duplicated; and
establishing mapping relationships between various pieces of byte data and the predetermined number of the selected characters.

11. The one or more computer-readable media of claim 10, wherein the predetermined number is 256.

12. The one or more computer-readable media of claim 9, wherein converting the information content of the message to be sent into the byte data comprises:
obtaining a character string corresponding to information content;
extracting values of the character string; and
using the extracted values as array elements to construct a byte array, and using elements of the byte array as byte data.

13. The one or more computer-readable media of claim 12, wherein prior to searching for the characters corresponding to the byte data from the pre-stored character set, the method further comprises adjusting data models of the elements according to respective byte lengths of the elements in the byte array, wherein different data models have different byte lengths.

14. The one or more computer-readable media of claim 13, wherein the data models of the elements comprise at least one of a byte type, an int type, or a long type.

15. The one or more computer-readable media of claim 13, wherein prior to searching for the characters corresponding to the byte data from the pre-stored character set, the method further comprises encrypting the elements in the byte array.

16. The one or more computer-readable media of claim 15, wherein the elements in the byte array are encrypted using an AES algorithm.

17. An apparatus comprising:
one or more processors;
memory;
a receiving module stored in the memory and executable by the one or more processors to receive a message from a sending party;
a searching module stored in the memory and executable by the one or more processors to find character data corresponding to information content of the message from a pre-stored character set, the character set includes predetermined byte data, predetermined characters, and mapping relationships between the predetermined byte data and the predetermined characters; and
a restoration module stored in the memory and executable by the one or more processors to restore the found character data to original information content of the message.

18. The apparatus of claim 17, wherein the pre-stored character set is determined by:
selecting a predetermined number of characters from a character set that is supported by messages according to a predetermined rule, the selected characters being not duplicated; and
establishing mapping relationships between various pieces of byte data and the predetermined number of the selected characters.

19. The apparatus of claim 17, wherein the searching module is further configured to find byte array corresponding to the information content from the pre-stored character set, wherein elements in the byte array are determined based on values of a character string, and the character string is used for representing original information content of the message.

20. The apparatus of claim 19, further comprising a decryption module to decrypt the found data in the pre-stored character set to obtain the byte array corresponding to the information content.
